(19) United States
(12) Patent Application Publication
(10) Pub. No.: US 2025/0002671 A1
(43) Pub. Date: Jan. 2, 2025

(54) DEPOLYMERIZATION SYSTEM AND DEPOLYMERIZATION METHOD

(71) Applicant: Honda Motor Co., Ltd., Tokyo (JP)

(72) Inventors: Tsuyoshi Baba, Wako-shi (JP); Shuta Suzuki, Wako-shi (JP)

(21) Appl. No.: 18/749,612

(22) Filed: Jun. 21, 2024

(30) Foreign Application Priority Data
Jun. 27, 2023 (JP) 2023-105290

(51) Int. Cl. C08J 11/14

(52) U.S. Cl. CPC C08J 11/14; C08J 2377/02

(57) ABSTRACT

A depolymerization system includes: a depolymerization apparatus configured to perform a depolymerization reaction between a molten resin supplied from the resin tank and a water supplied from the water tank; a pump configured to supply the molten resin from the resin tank to the depolymerization apparatus; and a pump control device. The pump control device comprises a microprocessor configured to perform: acquiring information of a viscosity of the molten resin, a density of the molten resin, and a pressure difference between the resin tank and the depolymerization apparatus; calculating a control command value corresponding to a target flow rate of the molten resin; calculating a volume efficiency of the pump based on the information of the viscosity, the density, and the pressure difference; correcting the control command value based on the volume efficiency; and outputting the corrected control command value to the pump.

### CROSS-REFERENCE TO RELATED APPLICATION

This application is based upon and claims the benefit of priority from Japanese Patent Application No. 2023-105290 filed on Jun. 27, 2023, the content of which is incorporated herein by reference.

### BACKGROUND

### Technical Field

The present invention relates to a depolymerization system and depolymerization method configured to recover a raw material from a plastic.

### Related Art

In recent years, efforts to significantly reduce the generation of waste have been activated by preventing, reducing, regenerating, and reusing the waste. In order to realize this, technology for chemically recycling waste plastic to convert it into a raw material has been known. As this type of technology, there is known an apparatus in which an alkali is added to a crushed PET-containing resin and pyrolysis treatment is performed to recover benzene (see, for example, JP 2008-133398 A). In the apparatus described in JP 2008-133398 A, the PET-containing resin and the alkali are continuously input into a pyrolyzer by a screw transfer type inputting apparatus.

Incidentally, when the raw material is recovered by depolymerizing the molten resin, it is conceivable to send the molten resin to a high-pressure depolymerization apparatus while applying a pressure using the above-described screw transfer type inputting device. However, the screw transfer type inputting device is expensive, which leads to an increase in cost.

### SUMMARY

An aspect of the present invention is a depolymerization system including: a resin tank configured to store a molten resin; a water tank configured to store water; and a depolymerization apparatus configured to perform a depolymerization reaction between the molten resin supplied from the resin tank and the water supplied from the water tank. The depolymerization system further includes: a pump of positive displacement configured to supply the molten resin from the resin tank to the depolymerization apparatus; and a pump control device configured to control the pump. The pump control device comprises a microprocessor. The microprocessor is configured to perform: acquiring information of a viscosity of the molten resin in the resin tank, information of a density of the molten resin in the resin tank, and information of a pressure difference between a pressure in the resin tank and a pressure in the depolymerization apparatus; calculating a control command value corresponding to a target flow rate of the molten resin; calculating a volume efficiency of the pump, based on the information of the viscosity, the information of the density, and the information of the pressure difference acquired in the acquiring; correcting the control command value based on the volume efficiency of the pump; and outputting the control command value corrected in the correcting to the pump.

Another aspect of the present invention is a depolymerization method of a depolymerization system. The depolymerization system includes: a resin tank configured to store a molten resin; a water tank configured to store water; a depolymerization apparatus configured to perform a depolymerization reaction between the molten resin supplied from the resin tank and the water supplied from the water tank, and a pump of positive displacement configured to supply the molten resin from the resin tank to the depolymerization apparatus. The depolymerization method includes: acquiring information of a viscosity of the molten resin in the resin tank, information of a density of the molten resin in the resin tank, and information of a pressure difference between a pressure in the resin tank and a pressure in the depolymerization apparatus; calculating a control command value corresponding to a target flow rate of the molten resin; calculating a volume efficiency of the pump, based on the information of the viscosity, the information of the density, and the information of the pressure difference acquired in the acquiring; correcting the control command value based on the volume efficiency of the pump; and outputting the control command value corrected in the correcting to the pump.

### BRIEF DESCRIPTION OF DRAWINGS

The objects, features, and advantages of the present invention will become clearer from the following description of embodiments in relation to the attached drawings, in which:

FIG. 1 is a diagram illustrating an example of a configuration of a depolymerization system according to the embodiment of the present invention;

FIG. 2 is a diagram illustrating a configuration of a main part of a pump control device that controls pumps of the depolymerization system;

FIG. 3 is a diagram illustrating processing executed by the controller of the pump control device;

FIG. 4A is a diagram illustrating information stored in the memory of FIG. 2;

FIG. 4B is a diagram illustrating information stored in the memory of FIG. 2;

FIG. 5 is a diagram illustrating a gear pump volume efficiency information;

FIG. 6 is a diagram illustrating another processing executed by the controller of FIG. 2; and

FIG. 7 is a diagram illustrating a water pump volume efficiency information.

### DETAILED DESCRIPTION

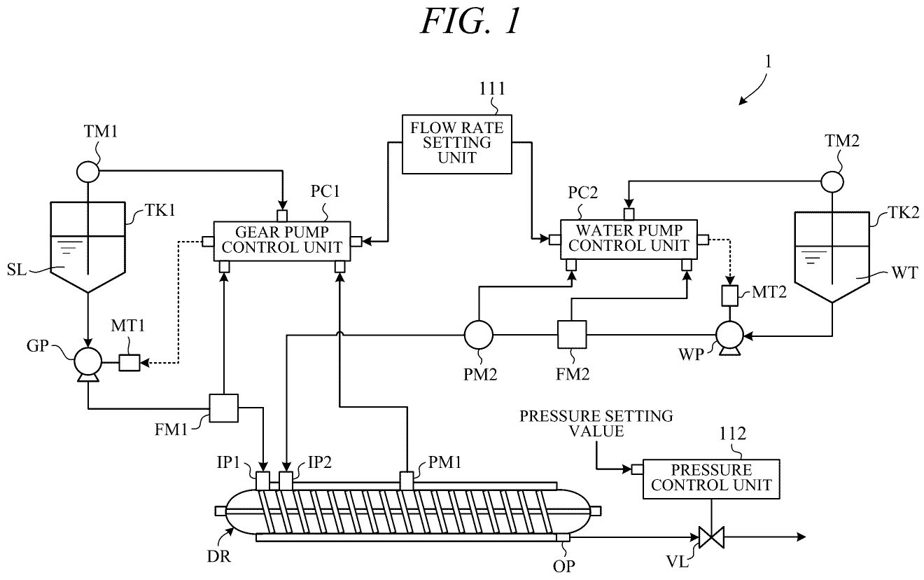

Hereinafter, an embodiment of the present invention will be described below with reference to FIGS. 1 to 7. A depolymerization system 1 according to the embodiment of the present invention depolymerizes waste plastic used for components (interior parts, bumpers, and the like) of a vehicle to recover a raw material. The waste plastic is polyamide 6 (hereinafter, referred to as PA6GF) blended with glass fibers (hereinafter, referred to as GF). The depolymerization system 1 depolymerizes polyamide 6 (hereinafter, referred to as PA6) contained in waste plastic and recovers caprolactam (hereinafter, referred to as CL). Note that the waste plastic may be other than PA6GF. That is, a polymer other than polyamide 6 may be depolymerized to recover a monomer other than caprolactam.

FIG. 1 is a diagram illustrating an example of a configuration of a depolymerization system according to the embodiment of the present invention. As illustrated in FIG. 1, the depolymerization system 1 includes a resin tank TK1 that stores a molten resin SL, a water tank TK2 that stores water WT, and a continuous depolymerization apparatus (hereinafter, simply referred to as a depolymerization apparatus) DR that performs a depolymerization reaction between the molten resin supplied from the resin tank TK1 and the water supplied from the water tank TK2. Specifically, the molten resin SL is PA6 (hereinafter, referred to as molten PA6) molten with ethylene glycol (hereinafter, referred to as EG).

The depolymerization system 1 further includes a pump GP that pumps the molten resin SL in the resin tank TK1 to the depolymerization apparatus DR, and a pump WP that pumps the water WT in the water tank TK2 to the depolymerization apparatus DR. The pumps GP and WP are positive displacement pumps, the pump GP is a gear pump, and the pump WP is a plunger pump. The depolymerization system 1 further includes a gear pump control unit PC1 that controls the pump GP, a water pump control unit PC2 that controls the pump WP, a flow rate setting unit 111, and a pressure control unit 112 that controls a back pressure valve VL installed on the output side (downstream side) of the depolymerization apparatus DR so as to maintain the pressure in the depolymerization apparatus DR at a designated pressure value (hereinafter, referred to as a pressure setting value).

Incidentally, when the molten PA6 and the water are supplied to the depolymerization apparatus DR, the internal volume of the depolymerization apparatus DR is constant, so that a residence time is determined by the supply amount, the internal temperature, and the pressure. On the other hand, volume efficiency of the gear pump that supplies the molten PA6 varies due to disturbance. When the volume efficiency of the gear pump varies, the residence time of the molten PA6 in the depolymerization apparatus DR is not stabilized. As a result, the yield of the produced monomer (CL) changes, and the monomer concentration of a treatment liquid (hereinafter, referred to as a depolymerization liquid) after the depolymerization reaction between the molten PA6 and the water (a ratio of CL contained in the depolymerization liquid to the water) changes. The depolymerization liquid is concentrated in a subsequent concentration process, and CL is recovered as a concentrated liquid (hereinafter, referred to as a concentrated CL solution) obtained by separating the water contained in the depolymerization liquid. However, when the monomer concentration of the depolymerization liquid changes as described above, the concentration of the concentrated CL solution does not become constant, and the quality is not stabilized. In order to cope with such a problem, in the present embodiment, the depolymerization system is configured as follows.

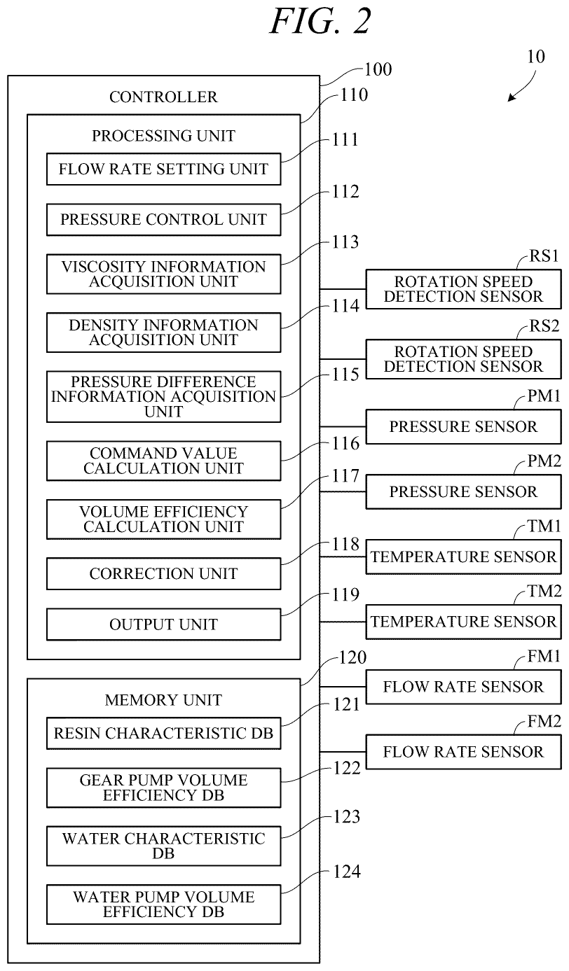

FIG. 2 is a diagram illustrating a configuration of a main part of a pump control device that controls the pumps GP and WP of the depolymerization system 1. As illustrated in FIG. 2, a pump control device 10 includes a controller 100, rotation speed detection sensors RS1 and RS2, pressure sensors PM1 and PM2, temperature sensors TM1 and TM2, and flow rate sensors FM1 and FM2. The controller 100 includes a computer including a processing unit 110 such as a CPU, a memory unit 120 such as a ROM or a RAM, and other peripheral circuits. Each of the rotation speed detection sensors RS1 and RS2, the pressure sensors PM1 and PM2, the temperature sensors TM1 and TM2, and the flow rate sensors FM1 and FM2 is connected to the controller 100.

The rotation speed detection sensor RS1 detects the rotation speed of the pump GP. More specifically, the rotation speed of the pump GP is the rotation speed of a motor MT1 that drives the pump GP. The rotation speed detection sensor RS2 detects the rotation speed of the pump WP. More specifically, the rotation speed of the pump WP is the rotation speed of a motor MT2 that drives the pump WP. The pressure sensors PM1 and PM2 detect the pressure in the depolymerization apparatus DR. The temperature sensor TM1 detects the temperature of the molten resin SL stored in the resin tank TK1. The temperature sensor TM2 detects the temperature of the water WT stored in the water tank TK2. The flow rate sensor FM1 detects the flow rate of the molten resin SL to be supplied from the pump GP to the depolymerization apparatus DR. The flow rate sensor FM2 detects the flow rate of the water WT to be supplied from the pump WP to the depolymerization apparatus DR.

The controller 100 includes the flow rate setting unit 111 and the pressure control unit 112 in FIG. 1 as functional configurations carried by the processing unit 110. Further, the controller 100 includes a viscosity information acquisition unit 113, a density information acquisition unit 114, a pressure difference information acquisition unit 115, a command value calculation unit 116, a volume efficiency calculation unit 117, a correction unit 118, and an output unit 119 as functional configurations carried by the processing unit 110. The components 113 to 119 function as the gear pump control unit PC1 in FIG. 1. Further, the components 113 to 119 function as the water pump control unit PC2 in FIG. 1.

The viscosity information acquisition unit 113 acquires information of the viscosity of the molten resin SL in the resin tank TK1. Specifically, the viscosity information acquisition unit 113 converts the viscosity from the temperature of the molten resin SL in the resin tank TK1 detected by the temperature sensor TM1 and acquires information of the viscosity of the molten resin SL. In addition, the viscosity information acquisition unit 113 acquires information of the viscosity of the molten resin SL in the water tank TK2. Specifically, the viscosity information acquisition unit 113 converts the viscosity from the temperature of the water WT in the water tank TK2 detected by the temperature sensor TM2 and acquires information of the viscosity of the water WT.

The density information acquisition unit 114 acquires information of the density of the molten resin SL in the resin tank TK1. Specifically, the density information acquisition unit 114 converts the density from the temperature of the molten resin SL in the resin tank TK1 detected by the temperature sensor TM1 and acquires information of the density of the molten resin SL. In addition, the density information acquisition unit 114 acquires information of the density of the water WT in the water tank TK2. Specifically, the density information acquisition unit 114 converts the density from the temperature of the water WT in the water tank TK2 detected by the temperature sensor TM2 and acquires information of the density of the water WT.

The pressure difference information acquisition unit 115 acquires information of a pressure difference ΔP1 between the pressure in the resin tank TK1 and the pressure in the depolymerization apparatus DR. In addition, the pressure difference information acquisition unit 115 acquires information of a pressure difference ΔP2 between the pressure in the water tank TK2 and the pressure in the depolymerization apparatus DR. Since the pressure in the resin tank TK1 is equal to the atmospheric pressure and the pressure (gauge pressure) in the depolymerization apparatus DR is high, the pressure difference information acquisition unit 115 acquires a detection value of the pressure sensor PM1 as information indicating the pressure difference ΔP1, when the resin tank TK1 is not pressurized. Similarly, since the pressure in the water tank TK2 is also equal to the atmospheric pressure, the pressure difference information acquisition unit 115 acquires a detection value of the pressure sensor PM2 as information indicating the pressure difference ΔP2, when the water tank TK2 is not pressurized.

The command value calculation unit 116 calculates a control command value of the pump GP corresponding to a target flow rate of the pump GP. Specifically, the command value calculation unit 116 calculates the rotation speed of the pump GP for discharging the target flow rate as the control command value. In addition, the command value calculation unit 116 calculates a control command value of the pump WP corresponding to a target flow rate of the pump WP. Specifically, the command value calculation unit 116 calculates the rotation speed of the pump WP for discharging the target flow rate as the control command value.

The volume efficiency calculation unit 117 calculates the volume efficiency of the pump GP based on the information of the viscosity of the molten resin SL acquired by the viscosity information acquisition unit 113, the information of the density of the molten resin SL acquired by the density information acquisition unit 114, and the information of the pressure difference ΔP1 acquired by the pressure difference information acquisition unit 115. In addition, the volume efficiency calculation unit 117 calculates the volume efficiency of the pump WP based on the information of the viscosity of the water WT acquired by the viscosity information acquisition unit 113, the information of the density of the water WT acquired by the density information acquisition unit 114, and the information of the pressure difference ΔP2 acquired by the pressure difference information acquisition unit 115.

The correction unit 118 corrects the control command value of the pump GP calculated by the command value calculation unit 116, based on the volume efficiency of the pump GP calculated by the volume efficiency calculation unit 117. In addition, the correction unit 118 corrects the control command value of the pump WP calculated by the command value calculation unit 116, based on the volume efficiency of the pump WP calculated by the volume efficiency calculation unit 117.

The output unit 119 outputs the control command value of the pump GP corrected by the correction unit 118 to the pump GP. More specifically, the output unit 119 converts the corrected control command value into a rotation speed command value of the motor MT1 and outputs the rotation speed command value to the motor MT1. In addition, the output unit 119 outputs the control command value of the pump WP corrected by the correction unit 118 to the pump WP. More specifically, the output unit 119 converts the corrected control command value into a rotation speed command value of the motor MT2 and outputs the rotation speed command value to the motor MT2.

The memory unit 120 includes a resin characteristic database (hereinafter, referred to as a DB) 121, a gear pump volume efficiency DB 122, a water characteristic DB 123, and a water pump volume efficiency DB 124.

The resin characteristic DB 121 stores resin characteristic information to be described later. The gear pump volume efficiency DB 122 stores gear pump volume efficiency information to be described later. The water characteristic DB 123 stores water characteristic information to be described later. The water pump volume efficiency DB 124 stores water pump volume efficiency information to be described later.

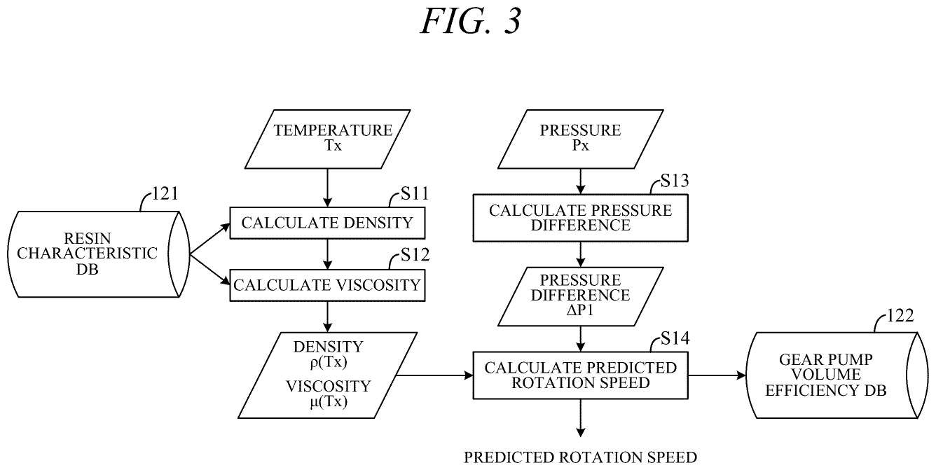

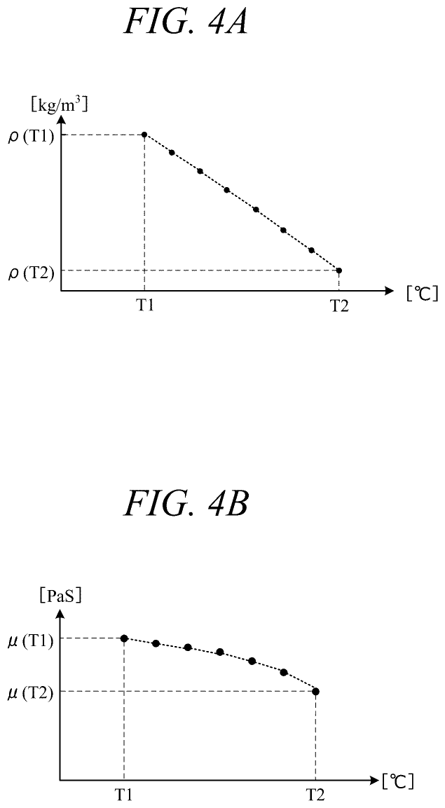

FIG. 3 is a diagram illustrating processing executed by the controller 100 of the pump control device 10. FIG. 3 illustrates an example of calculation processing of the control command value of the pump GP. As illustrated in FIG. 3, first, in steps S11 and S12, a density ρ(Tx) and a viscosity μ(Tx) of the molten resin SL are calculated from a detection value Tx of the temperature sensor TM1, based on the resin characteristic information stored in the resin characteristic DB 121. FIGS. 4A and 4B are diagrams illustrating the resin characteristic information stored in the resin characteristic DB 121. The resin characteristic information includes density information and viscosity information. FIG. 4A illustrates, as the density information, densities ρ(T1) to ρ(T2) corresponding to temperatures T1 to T2 (T1<Tx<T2). FIG. 4B illustrates, as the viscosity information, viscosities μ(T1) to μ(T2) corresponding to the temperatures T1 to T2.

As illustrated in FIGS. 4A and 4B, the density information and the viscosity information are information indicating a correlation between the temperature of the molten resin SL and the density and the viscosity thereof. The resin characteristic information is acquired in advance by an experiment or the like and stored in the resin characteristic DB 121. The density ρ(Tx) corresponding to the detection value Tx of the temperature sensor TM1 is calculated by the following Formula (i).

$$ρ = ( p ( T 2 ) - ρ ( T 1 ) ) / ( T 2 - T 1 ) * ( Tx - T 1 ) + ρ ( T 1 ) \qquad ( i )$$

Similarly, the viscosity μ(Tx) corresponding to the detection value Tx of the temperature sensor TM1 is calculated by the following Formula (ii).

$$μ ( Tx ) = ( μ ( T 2 ) - μ ( T 1 ) ) / ( T 2 - T 1 ) * ( Tx - T 1 ) + μ ( T 1 ) \qquad ( ii )$$

Next, in step S13, a pressure difference ΔP1 between the pressure in the resin tank TK1 and the pressure in the depolymerization apparatus DR is calculated. As described above, since the pressure in the resin tank TK1 is substantially the atmospheric pressure, a detection value Px of the pressure sensor PM1 is calculated as the pressure difference ΔP1 as it is.

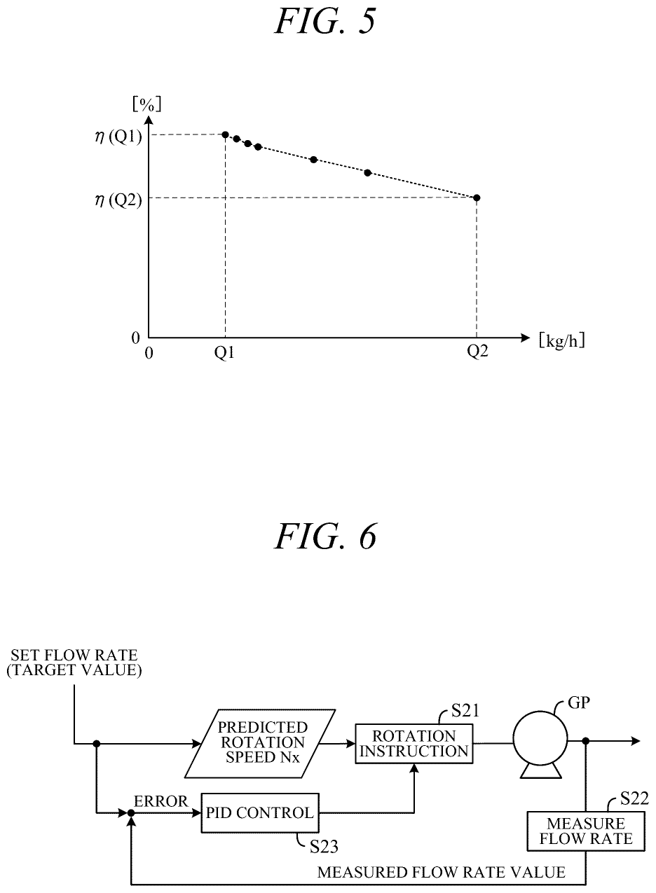

Finally, in step S14, an actual rotation speed of the pump GP is predicted. FIG. 5 is a diagram illustrating a performance curve of the pump GP indicated by the gear pump volume efficiency information stored in the gear pump volume efficiency DB 122. The performance curve in FIG. 5 represents a relation between the discharge flow rate (discharge flow rate per unit time) and the volume efficiency of the pump GP. FIG. 5 illustrates volume efficiencies η(Q1) to η(Q2) corresponding to discharge flow rates Q1 to Q2. Note that a discharge flow rate Q (n) per unit time of the pump GP when the rotation speed of the pump GP, more specifically, the rotation speed of the motor MT1 is n[rmp] and the viscosity of the molten resin SL is u is calculated by the following Formula (iii).

$$Q ( n ) = Δ P 1 / ( μ \times n ) \qquad ( iii )$$

When the target flow rate of the molten resin SL is q1 [kg/h], a theoretical rotation speed n1 of the pump GP corresponding to the target flow rate q1 is calculated by converting the volume flow rate using the information of the density and the viscosity of the molten resin SL. However, as illustrated in FIG. 5, since the volume efficiency decreases as the discharge flow rate of the pump GP increases, a desired discharge flow rate cannot be obtained even if the pump GP is rotated at the theoretical rotation speed n1. Therefore, in consideration of the characteristics of FIG. 5, the rotation speed n1 is corrected to predict the actual rotation speed of the pump GP. Specifically, the correction unit 118 corrects the rotation speed n1 based on data at the rotation speed n1 and the rotation speed n1+α using the following Formula (iv). Hereinafter, the actual rotation speed of the pump GP obtained by correcting the rotation speed n1 is referred to as a predicted rotation speed Nx. α is, for example, 10. In Formula (iv), RQ(n1) and RQ(n1+α) are predicted values of the actual discharge flow rates when the rotation speeds are n1 and n1+α, respectively, and are calculated by multiplying Q(n1) and Q(n1+α) by the corresponding volume efficiencies, respectively.

$$Nx = ( ( n 1 + α ) - n 1 ) / ( RQ ( n 1 ) - RQ ( n 1 + α ) ) * ( q 1 - RQ ( n 1 ) ) + n 1 \qquad ( iv )$$

FIG. 6 is a diagram illustrating another processing executed by the controller 100 of the pump control device 10. FIG. 6 illustrates an example of rotation control of the pump GP. In step S21, a rotation instruction is given to the pump GP according to the predicted rotation speed Nx calculated based on the target flow rate by the processing of FIG. 3. Specifically, a control command value corresponding to the predicted rotation speed Nx is output to the pump GP. In step S22, the discharge flow rate Q of the pump GP is measured. Specifically, the discharge flow rate Q of the pump GP detected by the flow rate sensor FM1 is acquired. In step S23, feedback control (PID control) is performed to reduce an error between the target flow rate q1 and the discharge flow rate Q to update the control command value. Then, the processing of steps S21 to S23 is repeated based on the updated control command value. Thereafter, the processing of steps S21 to S23 is repeatedly executed in a similar manner. As a result, the molten resin SL can be accurately supplied to the depolymerization apparatus DR according to the target flow rate.

The processing of FIG. 3 can also be applied to the calculation of the control command value of the pump WP. Specifically, first, a density ρ(Ty) and a viscosity μ(Ty) of the molten resin SL are calculated from a detection value Ty of the temperature sensor TM2, based on the water characteristic information stored in the water characteristic DB 123. Similarly to the resin characteristic information, the water characteristic information includes information (density information and viscosity information) indicating a correlation between the temperature of the water WT and the density and the viscosity thereof. The water characteristic information is acquired in advance by an experiment or the like and stored in the water characteristic DB 123. Next, the density ρ(Ty) and the viscosity μ(Ty) corresponding to the detection value Ty of the temperature sensor TM2 are calculated using the above (i) and (ii). Next, the pressure difference ΔP2 between the pressure in the water tank TK2 and the pressure in the depolymerization apparatus DR is calculated. Since the pressure in the water tank TK2 is also substantially the atmospheric pressure, the detection value Px of the pressure sensor PM2 is calculated as the pressure difference ΔP2 as it is.

Finally, the correction unit 118 predicts the actual rotation speed of the pump WP. Specifically, first, when the target flow rate of the water WT is q2 [kg/h], a theoretical rotation speed n2 of the pump WP corresponding to the target flow rate q2 is calculated by converting the volume flow rate using the information of the density p and the viscosity u of the water WT. In the plunger pump, since the rotational motion of the motor MT1 is converted into the reciprocating motion via a cam or a crank mechanism, the discharge flow rate of the pump W changes according to the rotation speed of the motor MT1. Specifically, as the rotation speed increases, the discharge amount per unit time increases. Further, as the pump W rotates at a lower speed, the internal leakage increases and the volume efficiency decreases. Therefore, the rotation speed n2 is calculated in consideration of the characteristic of the change in the discharge flow rate with respect to the rotation speed of the motor MT1. Further, the rotation speed n2 is calculated in consideration of the characteristic of the change in volume efficiency with respect to the rotation speed of the motor MT1.

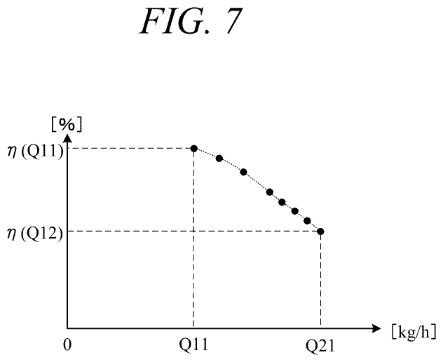

FIG. 7 is a diagram illustrating a performance curve of the pump WP indicated by the water pump volume efficiency information stored in the water pump volume efficiency DB 124. The performance curve in FIG. 7 represents a relation between the flow rate (flow rate per unit time) of the pump WP and the volume efficiency. FIG. 7 illustrates volume efficiencies η(Q11) to η(Q12) corresponding to discharge flow rates Q11 to Q12. The pump WP, which is the plunger pump, has higher volume efficiency than the pump GP, but when the pressure difference ΔP2 increases, liquid leakage or the like occurs from a gap between a cylinder and a plunger, and the volume efficiency decreases as illustrated in FIG. 7. The correction unit 118 corrects the rotation speed n2 to predict the actual rotation speed of the pump WP in consideration of the characteristics of FIG. 7. Hereinafter, the actual rotation speed of the pump WP obtained by correcting the rotation speed n2 is referred to as a predicted rotation speed Ny. Since a method for calculating the predicted rotation speed Ny is similar to the method for calculating the predicted rotation speed Nx described above, the description thereof will be omitted. The output unit 119 outputs the control command value corresponding to the predicted rotation speed Ny calculated as described above to the pump WP. Even in the rotation control of the pump WP, by repeating updating of the control command value by performing the feedback control (PID control) similar to that in FIG. 5, the water WT corresponding to the target flow rate q2 [kg/h] can be accurately discharged from the pump WP.

According to the present embodiment, the following operations and effects are achievable.

(1) The depolymerization system 1 includes: a resin tank TK1 that stores a molten resin SL; a water tank TK2 that stores water WT; and a depolymerization apparatus DR that performs a depolymerization reaction between the molten resin SL supplied from the resin tank TK1 and the water WT supplied from the water tank TK2. The depolymerization system 1 further includes: a pump GP that supplies the molten resin SL from the resin tank TK1 to the depolymerization apparatus DR; and a pump control device 10 that controls the pump GP. The pump control device 10 includes: a viscosity information acquisition unit 113 that acquires information of a viscosity of the molten resin SL in the resin tank TK1; a density information acquisition unit 114 that acquires information of a density of the molten resin SL in the resin tank TK1; a pressure difference information acquisition unit 115 that acquires information of a first pressure difference (pressure difference ΔP1) between a pressure in the resin tank TK1 and a pressure in the depolymerization apparatus DR; a command value calculation unit 116 that calculates a control command value (referred to as a first control command value) of the pump GP corresponding to a target flow rate (referred to as a first target flow rate) of the molten resin SL; a volume efficiency calculation unit 117 that calculates volume efficiency of the pump GP based on the information of the viscosity of the molten resin SL acquired by the viscosity information acquisition unit 113, the information of the density of the molten resin SL acquired by the density information acquisition unit 114, and the information of the first pressure difference acquired by the pressure difference information acquisition unit 115; a correction unit 118 that corrects the first control command value calculated by the command value calculation unit 116, based on the volume efficiency of the pump GP calculated by the volume efficiency calculation unit 117; and an output unit 119 that outputs the first control command value corrected by the correction unit 118 to the pump GP. The depolymerization system 1 further includes a back pressure valve VL that is provided on the output side of the depolymerization apparatus DR to adjust the pressure in the depolymerization apparatus DR. As a result, the molten resin SL can be accurately supplied to the high-pressure depolymerization apparatus DR with a gear pump cheaper than a twin screw extruder. In addition, since a residence time of the molten resin SL in the depolymerization apparatus DR can be caused to be constant, a variation in the yield of a produced monomer can also be suppressed.

(2) The pump control device 10 further includes a flow rate sensor FM1 that detects a discharge flow rate of the pump GP. The correction unit 118 calculates an error (referred to as a first error) between a detection value of the flow rate sensor FM1 as a first flow rate detection unit and the first target flow rate, and updates the first control command value of the pump GP based on the first error. The output unit 119 outputs the updated first control command value to the pump GP. As a result, a variation in the flow rate of the pump GP can be suppressed, and the molten resin SL can be accurately supplied to the depolymerization apparatus DR according to the target flow rate.

(3) The depolymerization system 1 further includes a pump WP that supplies the water WT from the water tank TK2 to the depolymerization apparatus DR. Further, the pump control device 10 controls the pump WP. In this case, the viscosity information acquisition unit 113 acquires information of the viscosity of the water WT in the water tank TK2, the density information acquisition unit 114 acquires information of the density of the water WT in the water tank TK2, the pressure difference information acquisition unit 115 acquires information of a second pressure difference (pressure difference ΔP2) between the pressure in the water tank TK2 and the pressure in the depolymerization apparatus DR, and calculates a control command value (referred to as a second control command value) of the pump WP corresponding to a target flow rate (referred to as a second target flow rate) of the water WT, the volume efficiency calculation unit 117 calculates volume efficiency of the pump WP based on the information of the viscosity of the water WT acquired by the viscosity information acquisition unit 113, the information of the density of the water WT acquired by the density information acquisition unit 114, and the information of the second pressure difference acquired by the pressure difference information acquisition unit 115, the correction unit 118 corrects the second control command value calculated by the command value calculation unit 116, based on the volume efficiency of the pump WP calculated by the volume efficiency calculation unit 117, and the output unit 119 outputs the second control command value corrected by the correction unit 118 to the pump WP. The depolymerization system 1 further includes a flow rate sensor FM2 that detects a discharge flow rate of the pump WP as a second flow rate detection unit. The correction unit 118 calculates an error (referred to as a second error) between a detection value of the flow rate sensor FM2 and the second target flow rate and updates the second control command value based on the second error, and the output unit 119 outputs the updated second control command value to the pump WP. As a result, a variation in the flow rate of the pump WP can be suppressed, and the water WT can be accurately supplied to the depolymerization apparatus DR according to the target flow rate.

The above embodiment can be modified into various forms. Modifications are described below.

In the above embodiment, the example has been described in which the depolymerization system 1 depolymerizes PA6 contained in PA6GF to recover caprolactam, but the waste plastic may be other than PA6GF. That is, the depolymerization system may depolymerize a polymer other than PA6 to recover a monomer other than caprolactam.

In the above embodiment, the rotation speed detection sensor RS1 as the first rotation speed detection unit detects the rotation speed of the motor MT1 that drives the pump GP as the first pump as the rotation speed of the pump GP. Further, the rotation speed detection sensor RS2 as the second rotation speed detection unit detects the rotation speed of the motor MT2 that drives the pump WP as the second pump as the rotation speed of the pump WP. However, the configurations of the first rotation speed detection unit and the second rotation speed detection unit are not limited thereto. For example, the first rotation speed detection unit may detect the rotation speed of the pump GP from the pump GP.

In the above embodiment, the case where the pump WP as the second pump is the plunger pump has been described as an example, but the second pump may be a diaphragm pump. Furthermore, in the above embodiment, the example in which the back pressure valve VL is provided on the downstream side of the depolymerization apparatus DR has been described. However, a flow rate control valve may be provided instead of the back pressure valve VL, and the pressure control unit 112 may control the flow rate control valve so as to maintain the pressure in the depolymerization apparatus DR at a designated pressure value (pressure setting value).

The above embodiment can be combined as desired with one or more of the above modifications. The modifications can also be combined with one another.

According to the present invention, it is possible to suppress a variation in yield of a raw material at low cost.

Above, while the present invention has been described with reference to the preferred embodiments thereof, it will be understood, by those skilled in the art, that various changes and modifications may be made thereto without departing from the scope of the appended claims.

What is claimed is:

1. A depolymerization system comprising:
a resin tank configured to store a molten resin;
a water tank configured to store water; and
a depolymerization apparatus configured to perform a depolymerization reaction between the molten resin supplied from the resin tank and the water supplied from the water tank, wherein
the depolymerization system further comprises: a pump of positive displacement configured to supply the molten resin from the resin tank to the depolymerization apparatus; and a pump control device configured to control the pump, and
the pump control device comprises a microprocessor, and wherein
the microprocessor is configured to perform:
acquiring information of a viscosity of the molten resin in the resin tank, information of a density of the molten resin in the resin tank, and information of a pressure difference between a pressure in the resin tank and a pressure in the depolymerization apparatus;
calculating a control command value corresponding to a target flow rate of the molten resin;
calculating a volume efficiency of the pump, based on the information of the viscosity, the information of the density, and the information of the pressure difference acquired in the acquiring;
correcting the control command value based on the volume efficiency of the pump; and
outputting the control command value corrected in the correcting to the pump.

2. The depolymerization system according to claim 1, wherein
the pump control device further comprises a flow rate sensor configured to detect a discharge flow rate of the pump, and
the microprocessor is configured to perform:
the correcting including calculating an error between a detection value of the flow rate sensor and the target flow rate, and updating the control command value of the pump based on the error; and
the outputting including outputting the control command value updated in the updating to the pump.

3. The depolymerization system according to claim 1, wherein
the pump is a first pump, the control command value is a first control command value, the pressure difference is a first pressure difference, and the target flow rate is a first target flow rate,
the depolymerization system further comprises a second pump of positive displacement configured to supply the water from the water tank to the depolymerization apparatus, and
the microprocessor is configured to perform:
the acquiring including acquiring information of the viscosity of the water in the water tank, information of the density of the water in the water tank, and information of a second pressure difference between the pressure in the water tank and the pressure in the depolymerization apparatus;
the calculating of the control command value including calculating a second control command value corresponding to a second target flow rate of the water;
the calculating of the volume efficiency including calculating a volume efficiency of the second pump, based on the information of the viscosity of the water, the information of the density of the water, and the information of the second pressure difference acquired in the acquiring;
the correcting including correcting the second control command value, based on the volume efficiency of the second pump; and
the outputting including outputting the second control command value corrected in the correcting to the second pump.

4. The depolymerization system according to claim 3, wherein
the flow rate sensor is a first flow rate sensor,
the depolymerization system further comprises a second flow rate sensor configured to detect a discharge flow rate of the second pump, and
the microprocessor is configured to perform:
the correcting including calculating an error between a detection value of the second flow rate sensor and the second target flow rate, and updating the second control command value of the pump based on the error; and
the outputting including outputting the second control command value updated in the updating to the second pump.

5. The depolymerization system according to claim 3, wherein
the first pump is a gear pump and the second pump is a plunger pump,
the first control command value is rotation speed of a motor for driving the gear pump and the second control command value is rotation speed of a motor for driving the plunger pump.

6. The depolymerization system according to claim 1 further comprising
a back pressure valve provided on an output side of the depolymerization apparatus and configured to adjust the pressure in the depolymerization apparatus.

7. The depolymerization system according to claim 1 further comprising
a flow rate control valve provided on an output side of the depolymerization apparatus and configured to adjust the pressure in the depolymerization apparatus.

8. A depolymerization method of a depolymerization system, the depolymerization system comprising: a resin tank configured to store a molten resin; a water tank configured to store water; a depolymerization apparatus configured to perform a depolymerization reaction between the molten resin supplied from the resin tank and the water supplied from the water tank, and a pump of positive displacement configured to supply the molten resin from the resin tank to the depolymerization apparatus, and the depolymerization method comprising:
acquiring information of a viscosity of the molten resin in the resin tank, information of a density of the molten resin in the resin tank, and information of a pressure difference between a pressure in the resin tank and a pressure in the depolymerization apparatus;
calculating a control command value corresponding to a target flow rate of the molten resin;
calculating a volume efficiency of the pump, based on the information of the viscosity, the information of the density, and the information of the pressure difference acquired in the acquiring;
correcting the control command value based on the volume efficiency of the pump; and
outputting the control command value corrected in the correcting to the pump.
